(19) United States
(12) Patent Application Publication
(10) Pub. No.: US 2003/0133109 A1
(43) Pub. Date: Jul. 17, 2003

(54) Real time LASER and LED detection system using a hyperspectral imager

(76) Inventor: James E. Murguia, Hollis, NH (US)

Correspondence Address: Kathleen Sakati, 11 Fairway Drive, Hudson, NH, 03051, US

(21) Appl. No.: 10/047,156

(22) Filed: Jan. 17, 2002

(51) Int. Cl. G01J 3/28

(52) U.S. Cl. 356/326; 356/328

(57) ABSTRACT

Tomographic approaches to hyperspectral imaging, such as CTHIS¹ (Chromotomographic Hyperspectral Imaging Sensor), can eliminate the need for the slit, filter, or resonant cavity and substantially increase the optical throughput of the system. These systems capture a large fraction of the photon energy from the entire spectral band over the entire frame time. CTHIS uses a rotating direct view prism as the dispersing element, consequently, the extended image must be reconstructed from the blurred measured data. Only radiation from monochromatic sources such as LEDs, LASERs and signals with high spectral definition, such as the flames of chemical reactions, remain un-blurred in passing through the prism. Thus, the position, wavelength, and temporal evolution of LEDs, LASERs and certain flames can be easily identified in a wide field of view with minimal signal processing.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of Invention

The present invention generally relates to a technique for the identification of monochromatic radiation, and in particular, the present invention relates to a method for using a new class of hyperspectral imagers to identify the position and wavelength of incoming monochromatic radiation from LASERs and LEDs in a wide field of view.

2. Description of Related Art

Spectral imagers sense radiation intensity both spatially and spectrally. Typical hyperspectral imagers either scan a slit across the scene FIG. 10, iterate through a sequence of narrow band filters FIG. 11, or move an interferometer mirror to construct the image FIG. 11, as shown in FIG. 1. To obtain high spectral resolution, the slit is made thin, the filter is made narrow, or the finesse is made high. These restrictions limit the amount of light passed by the optical system. In general, the performance of a hyperspectral imager is limited by the optical throughput. The low optical throughput of most hyperspectral optical systems limits the application of the sensor, and makes the simultaneous measurement of all four dimensions (2 spatial, 1 spectral and 1 temporal) impractical. Conventional LASER detectors measure only three of the above dimensions, namely, position (2) and time (1) at a given wavelength, position (2) and wavelength (1) at a given time, or one dimension of position (1), time (1) and wavelength (1).

### BRIEF SUMMARY OF INVENTION

FIG. 2 is a schematic representation of a ChromoTomographic Hyperspectral Imaging Sensor, CTHIS, consisting of a telescope 20, a field stop 21, a direct vision prism 22, a focus lens 23, and a focal plane array 24.

A direct vision prism consists of two prisms that are arranged such that one wavelength passes undeviated, while the other wavelengths are dispersed along a line. The direct vision prism is mounted on a bearing so that it can be rotated around the optical axis. As the prism is rotated, the spectral features trace out circles with wavelength dependent radii. The projected image is dispersed on the focal plane array. Computational methods are used to reconstruct the scene as a three-dimensional spectral image, or “data cube.” The approach is tomographic, and similar to the limited-angle tomography techniques used in medicine.

In the CTHIS tomographic system, all photons that pass through the sensor field stop are imaged onto the focal plane 12. This continues for a full integration time, wherein the prism rotates 360 degrees. To ease measurement and computation, rotation is often carried out in N discrete steps of 360/N degrees. This super-integration requires a de-multiplexing operation to extract the spectral imagery from the measured data. As an added benefit, the mathematical reconstruction in chromotomography simultaneously returns the data cube and the principal components of the spectral image. It is thus an objective of the present invention to utilize the 4-dimentional measurement of position (2), time and wavelength, and high optical throughput of the CTHIS spectral sensor to provide the increased signal information needed for the detection of monochromatic radiation.

It is thus a further objective of the present invention to provide a spectral detector architecture capable of sensing monochromatic, or near monochromatic, radiation in a wide field of view.

### BRIEF DESCRIPTION OF THE SEVERAL VIEWS OF THE DRAWING

The above and other features and advantages of the present invention will become readily apparent from the description that follows, with references to the accompanying drawings, in which:

FIG. 1 illustrates a comparison of the hypercube signal acquisition space measured (or mapped) by a scanned slit FIG. 10, a filter wheel (or interferometer) FIG. 11, and the CTHIS tomographic hyperspectral FIG. 12 imager.

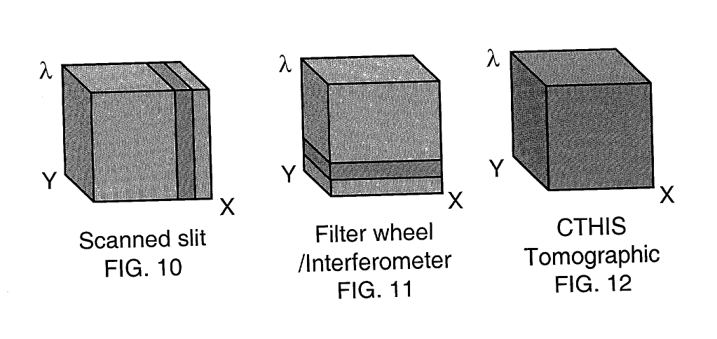

FIG. 2 illustrates a schematic representation of a chromotomographic spectral imager. The direct view prism or grating 22 is shown spreading red, green, and blue light across the focal plane array 24.

### DETAILED DESCRIPTION OF THE INVENTION

Hyperspectral imagers quantify the spatial and spectral characteristics of a scene typically using a scanned slit FIG. 10, filter wheel or interferometer FIG. 11. These instruments operate by dispersing the light from a slit image over a two-dimensional focal plane array, the spectrum of a slit of pixels is measured, the slit is advanced by one slit width, and then the spectrum of the next slit of pixels is measured. Alternatively, the instrument iterates through a sequence of narrow band filters, or moves an interferometer mirror. To obtain high spectral resolution, the slit is made thin, the filter is made narrow, or the cavity finesse is made high. However, a thin slit, narrow filter, or high finesse cavity limit the amount of light passed by the optical system, reducing the signal to noise ratio of the image In general, the performance of these hyperspectral imagers is limited by the poor optical throughput of the slit (the AΩ product). Nevertheless, slit instruments provide the baseline against which all other spectral imaging instruments are compared.

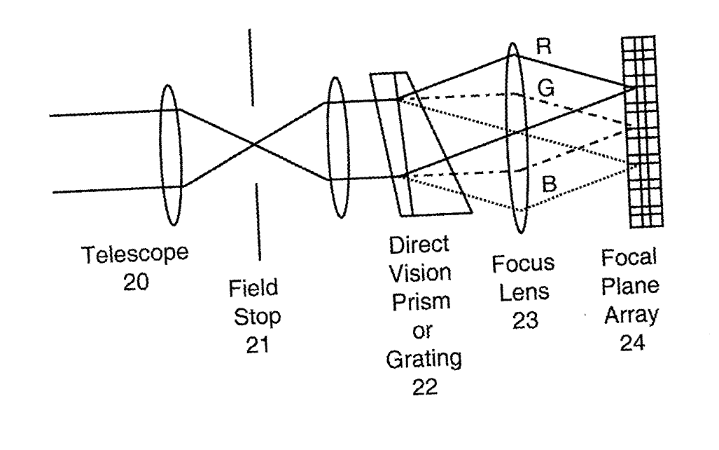

FIG. 2 is a schematic representation of a chromotomographic hyperspectral imaging sensor, consisting of a telescope 20, a field stop 21, a direct vision prism 22, a focus lens 23, and a focal plane array 24. A direct vision prism consists of two prisms that are arranged such that one wavelength passes undeviated, while the other wavelengths are dispersed along a line, or dispersion axis. An image projected onto the focal plane will be dispersed along this axis. The direct vision prism is mounted on a bearing so that it can be rotated on the optical axis of the telescope. During the measurement of successive video frames, the dispersion axis is rotated, causing the image of spectral features to trace out circles with wavelength-dependent radii. This has the affect of multiplexing the color information of the image over the array, which, otherwise, is operating as a broad band polychromatic sensor. Tomographic computational methods that are similar to the limited-angle tomography techniques used in medicine are used to reconstruct the scene.

The sensor tomographic technique can be summarized as follows. During a video frame, a large fraction of the photons from the observed scene, which pass through the field stop, are detected by the focal plane array FIG. 12. This includes all photons within the spectral response range of the detector. During successive frames, the rotating prism multiplexes spectral features over the focal plane array. An image source emitting or reflecting a broad range of wavelengths is dispersed by the prism. Video frames are collected over a full prism rotation. This super-integration requires a de-multiplexing operation to extract the spectral imagery from the measured data.

The reconstruction of a monochromatic point source scene is simplified and does not require a de-multiplexing operation to extract the spectral imagery from the measured data. Dispersion of a monochromatic point source focused on the sensor results in a simple displacement of the point image on the focal plane As the prism is rotated the displaced point image traces out a circle on the focal plane. The radius of the circle corresponds to the wavelength of the radiation as displaced/encoded by the prism (1 dimension), and the origin of the circle is the location of the laser (2 dimensions). A fast framing staring imaging array can be employed to measure the temporal evolution of the radiation (1 dimension).

Signals from near-monochromatic sources, such as the red or blue spike from a plume, will give similar results, except the trace of the circle will be slightly blurred by the finite spectral bandwidth of the illumination.

What I claim my invention is:

1) A sensor for detecting and identifying mono-chromatic or nearly mono-chromatic radiation from a point source in a wide field of view that consists of:
A telescope,
An aperture,
A rotating direct vision prism that allows a center wavelength within its band-pass to pass un-deviated while dispersing shorter wavelengths in one direction and longer wavelengths in the other,
A focus lens,
And,
A broadband imaging camera.

1a) A sensor described in (1) that:
Does not contain the telescope.

1b) A sensor described in (1) that:
Does not contain the aperture.

1c) A sensor described in (1) that:
Does not contain the telescope or the aperture.

1d) A sensor described in (1) that:
Does not rotate the direct vision prism.

1e) A sensor described in (1) that:
Contains a grating instead of a direct vision prism.

1f) A sensor described in (1) that:
Contains one or more direct vision prisms.
